(19) United States
(12) Patent Application Publication
(10) Pub. No.: US 2013/0093583 A1
(43) Pub. Date: Apr. 18, 2013

(54) AUTOMOTIVE PANEL WARNING AND PROTECTION SYSTEM

(71) Applicant: Alan D. Shapiro, Potomac Falls, VA (US)

(72) Inventor: Alan D. Shapiro, Potomac Falls, VA (US)

(21) Appl. No.: 13/273,628

(22) Filed: Oct. 14, 2011

(51) Int. Cl. B60Q 1/00; G06F 19/00; H04N 7/18; G01S 3/80

(52) U.S. Cl. 340/436; 367/118; 701/301; 348/148; 348/E07.085

(57) ABSTRACT

The present disclosure relates generally to an automotive panel warning and protection system that enables vehicle operators to detect and avoid collisions between objects and low-height portions or panels of the underside of a vehicle. A vehicle is equipped with a range detector, video camera, or combination of both that is positioned on the vehicle such that it is able to determine a vertical clearance of a portion of the underside of the vehicle and an object external to the vehicle. If the vertical clearance is determined to fall below a vertical clearance threshold, the driver may be alerted. An interface system resident in the vehicle cabin may provide the vehicle operator with real-time visual information depicting spatial relationships between the external object and the vehicle and/or the portion of the underside of the vehicle that is determined not to have sufficient vertical clearance.

### TECHNICAL FIELD

The present disclosure relates generally to an automotive panel warning and protection system that may be used to aid vehicle operators in avoiding potential collisions with objects external to the vehicle.

### BACKGROUND

Vehicle blind spots can have consequences ranging from simple damage to the vehicle or other property to the danger of injuring or killing animals or humans. One solution that has been proposed and, in some vehicles, implemented to prevent collisions with persons or objects on account of blind spots has been to embed one or more collision detection devices in vehicle bumpers. Such collision detection devices may enable a vehicle operator to detect a potential collision by sensing objects that might otherwise not be visible while driving.

For example, as depicted in FIG. 1, a vehicle 110 may be equipped with a range detector, such as an ultrasonic range finder 115, in the bumper. The ultrasonic range finder 115 may determine the horizontal distance 117 between the range finder 115 (representing the front end of vehicle 110) and an object 120, such as a wall, by transmitting one or more sound waves at frequencies greater than the upper limit of human hearing (e.g., greater than 20 kHz), determining how long it takes for such sound waves to reflect off of any nearby objects and return to the ranger finder, and, based on the delayed reception, determine the distance between the vehicle and nearby objects. Using this technique, if range finder 115 determines that vehicle 110 has come within a certain distance of a nearby object and is continuing to approach that object, componentry attached to the range finder (e.g., in the cabin of the vehicle) may alert the driver by emitting a sound or providing another type of indication.

Conventional range detectors, however, suffer from a number of drawbacks. Most importantly, range detectors offer vehicle operators only information that the vehicle is drawing close to some object without specifying what the object is or the precise location or size of the object. Accordingly, other prior art approaches for avoiding vehicle collisions with nearby objects have centered around the use of video cameras to provide operators with a view of any nearby objects.

For example, as depicted in FIG. 2, a vehicle 210 may be equipped with one or more video cameras 215 embedded into the vehicle's bumper. Such video cameras 215 may be connected to a video display screen in the cabin of vehicle 210 (not depicted) that displays one or more video feeds provided by video cameras 215. Using this approach, the operator of vehicle 215 may be able to visually observe objects—here, a child 220—that would otherwise not be visible merely by looking through any rear windows or rear-view mirrors. Thus, in this example, the vehicle operator, upon seeing a child in the rear video display, might immediately cease any backward motion, in contrast to a range detector that might not alert the driver of the potential obstacle until the vehicle is closer to the child.

However, conventional collision avoidance devices, such as range detectors and video monitors, are not effective in avoiding all types of collisions. For example, as depicted in FIG. 3, a vehicle 310 may be approaching an object 320 having low height relative to the vehicle, such as a parking block. In this example, a range detector 315 may be ineffective at identifying a potential collision with object 320 because the range detector, being placed at a higher vertical position than the object, may not detect a horizontal collision between its position and the object. However, as can be seen in FIG. 3, certain portions of the vehicle 310, such as the underside and lower front surface of the bumper 317, may be too low to clear the object 320. In this case, because range detector 315 may not provide any warning to the vehicle operator, the operator may continue to approach object 320 until its underside 317 starts to scrape against the object 320.

Conventional video-based systems may fare no better under these circumstances. Although the vehicle operator may be able to see a video feed depicting the object 320 from the cabin of the vehicle, the video camera would not be able to show the operator whether a portion of the vehicle that is both below and behind the camera 315 has sufficient height to vertically clear the object 320.

Accordingly, there is a need for an improved vehicle collision detection and avoidance system that enables vehicle operators to avoid collisions with objects that, due to their low height relative to a vehicle, would not be detected by conventional collision avoidance systems.

### SUMMARY OF THE INVENTION

The present disclosure provides for an automotive panel warning and protection system that enables vehicle operators to detect and avoid collisions between objects and low-height portions or panels of the underside and front of a vehicle. In the disclosed embodiments, a vehicle is equipped with a range detector, video camera, or combination of both that is positioned on the vehicle such that it is able to determine a vertical clearance of a portion of the underside or front of the vehicle and an object external to the vehicle. If the vertical clearance is determined to fall below a vertical clearance threshold, the driver may be alerted.

In some embodiments, the automotive panel warning and protection system may additionally determine a horizontal distance between the portion of the underside or lower front of the vehicle and the external object, and may alert a vehicle operator only once the horizontal distance falls below a certain threshold. The nature and/or extent of alerts provided to the operator may be changed if the vehicle continues to approach the external object. Or, the system itself may take automated corrective action, such as applying vehicle brakes, adjusting suspension or hydraulics, raising a bumper or underside panel, etc.

In some embodiments, an interface system resident in the vehicle cabin may provide the vehicle operator with real-time visual information depicting spatial relationships between the external object and the vehicle and/or the portion of the underside/lower front of the vehicle that is determined not to have sufficient vertical clearance. Such visual information may comprise a real-time video display provided by a camera attached to the underside of the vehicle. Such visual information may additionally or alternatively comprise a virtual grid depicting the spatial relationships from an angle not otherwise observable through camera componentry resident on the vehicle.

### BRIEF DESCRIPTION OF THE DRAWINGS

The accompanying drawings, which are incorporated in and constitute a part of this specification, illustrate various embodiments of the invention and, together with the description, serve to explain the principles of the invention. In the drawings:

FIG. 1 is a diagram depicting a prior art approach of using horizontal measurements between a vehicle and an external object to avoid head-on collisions;

FIG. 2 is a diagram depicting a prior art approach of using video-based feedback techniques to avoid head-on collisions with external objects;

FIG. 3 is a diagram depicting drawbacks of prior art approaches to avoiding collisions;

FIG. 4 is a diagram depicting an exemplary hardware configuration for an improved vehicle collision detection and avoidance system, consistent with certain disclosed embodiments;

FIG. 5a is a diagram depicting a portion of an improved vehicle collision detection and avoidance device, consistent with certain disclosed embodiments;

FIG. 5b is a diagram depicting a portion of an improved vehicle collision detection and avoidance device, consistent with certain disclosed embodiments;

FIG. 5c is a diagram depicting a portion of an improved vehicle collision detection and avoidance device, consistent with certain disclosed embodiments;

FIG. 5d is a diagram depicting a portion of an improved vehicle collision detection and avoidance device, consistent with certain disclosed embodiments;

FIG. 6 is a flow diagram depicting an exemplary method of detecting and avoiding collisions with low-height objects, consistent with certain disclosed embodiments;

FIG. 7a is a diagram depicting an exemplary operation of an improved collision detection and avoidance system, consistent with certain disclosed embodiments;

FIG. 7b is a diagram depicting an exemplary operation of an improved collision detection and avoidance system, consistent with certain disclosed embodiments;

FIG. 7c is a diagram depicting an exemplary operation of an improved collision detection and avoidance system, consistent with certain disclosed embodiments;

FIG. 8 is a diagram depicting an exemplary video display to assist a vehicle operator in detecting and avoiding collisions with low-height objects, consistent with certain disclosed embodiments; and

FIG. 9 is a diagram depicting an exemplary computer-generated virtual clearance grid to assist a vehicle operator in detecting and avoiding collisions with low-height objects, consistent with certain disclosed embodiments.

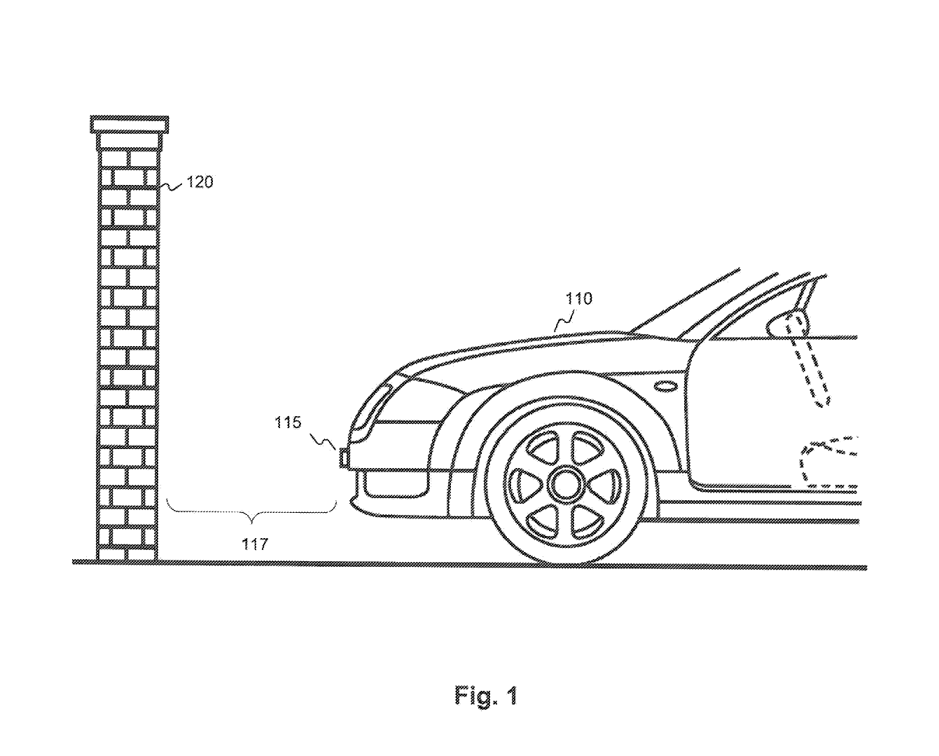

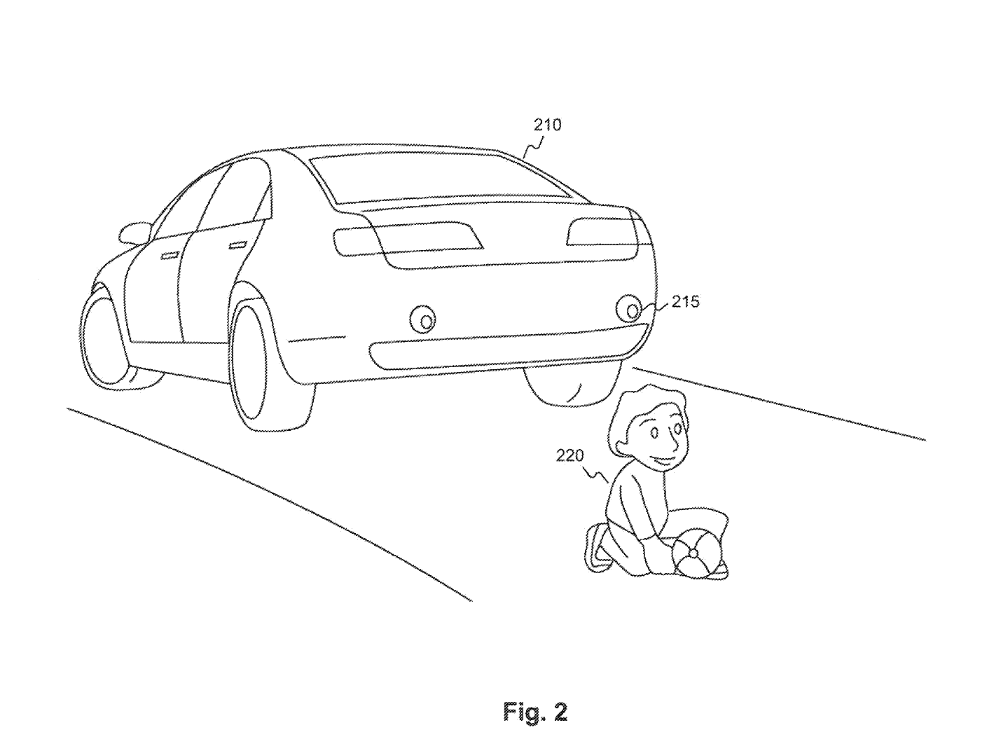

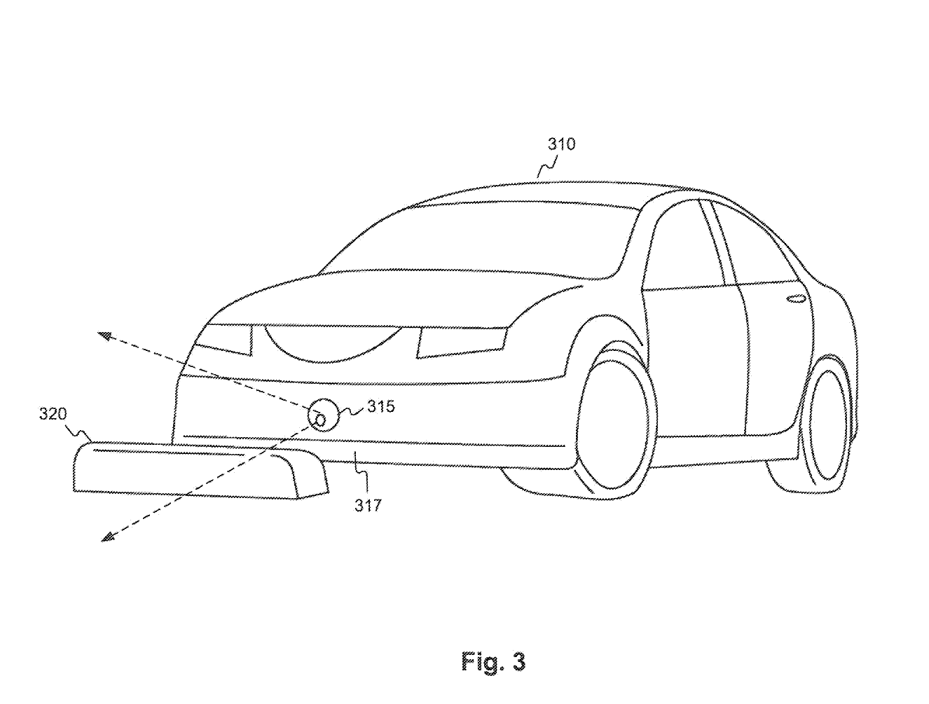

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible, without departing from the spirit and scope of the invention. Accordingly, the following detailed description does not limit the invention. Instead, the proper scope of the invention is defined by the appended claims.

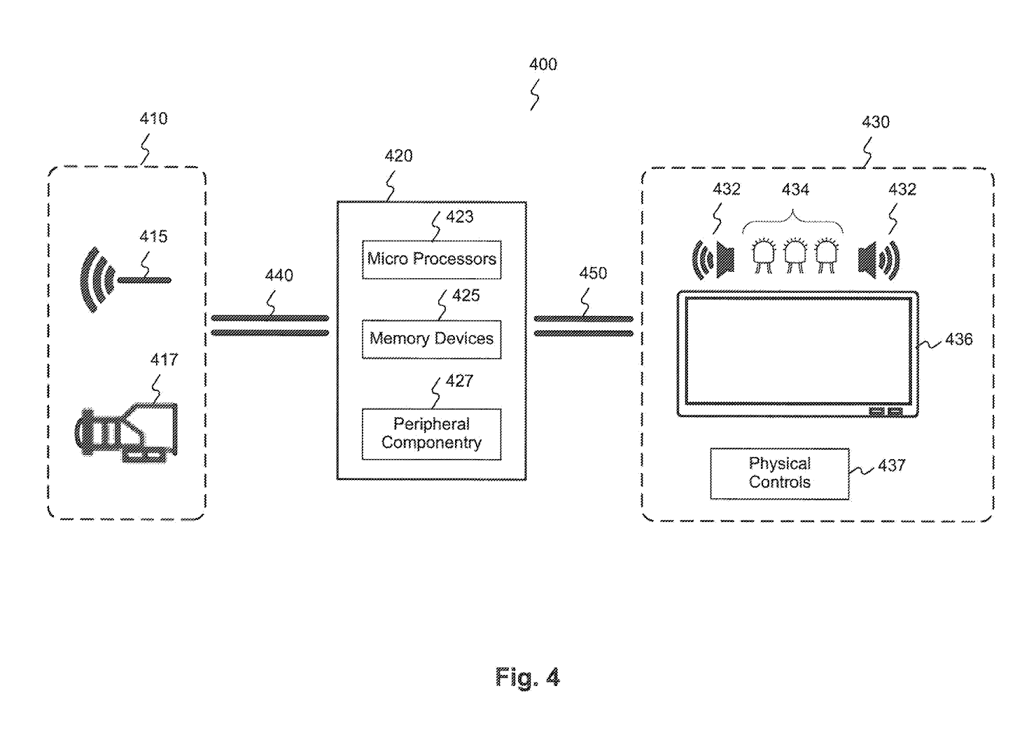

FIG. 4 is a diagram depicting an exemplary hardware configuration for an improved vehicle collision detection and avoidance system, consistent with certain disclosed embodiments. As described above, the invention may be used to detect and prevent against collisions between certain portions or panels on the underside or lower front of a vehicle and certain low height external objects that may otherwise avoid detection by conventional collision avoidance systems. As depicted in FIG. 4, panel protection system 400 may comprise a sensory system 410, a processing system 420, and a cabin interface system 430.

Sensory system 410 may comprise components of panel protection system 400 that are affixed to external surfaces of a vehicle and operate to detect objects external to the vehicle and/or to provide electrical or electronic information related to distances between one or more portions of the vehicle and the external objects. Sensory system 410 may include one or more range detectors 415. Range detectors 415 may include one or more devices capable of determining physical proximity to one or more external objects, such as an ultrasonic range finder.

Sensory system 410 may also include one or more camera devices 417, such as digital or analog video cameras, configured to capture images of external objects in real time and provide such images to processing system 410 as part of a continual electrical, electronic, or signal-based data feed through one or more connections 440. Connections 440 may comprise, for example, physical wiring or short-range radio wave transmissions for providing data, signals, or instructions to processing system 420 and/or vice-versa. Sensory system 410 may also comprise one or more illumination components to provide adequate lighting for any camera device 417, such as infrared lighting that will not be visible to human eyes and thus will not violate any applicable regulations on external vehicle lighting.

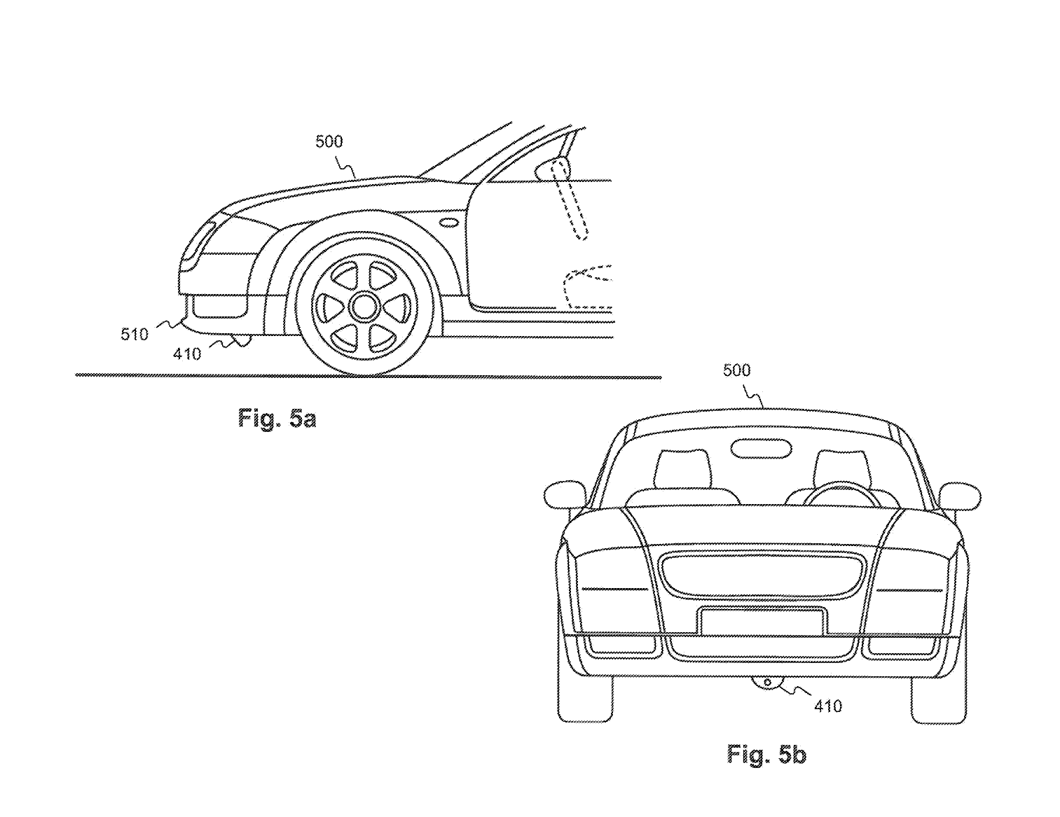

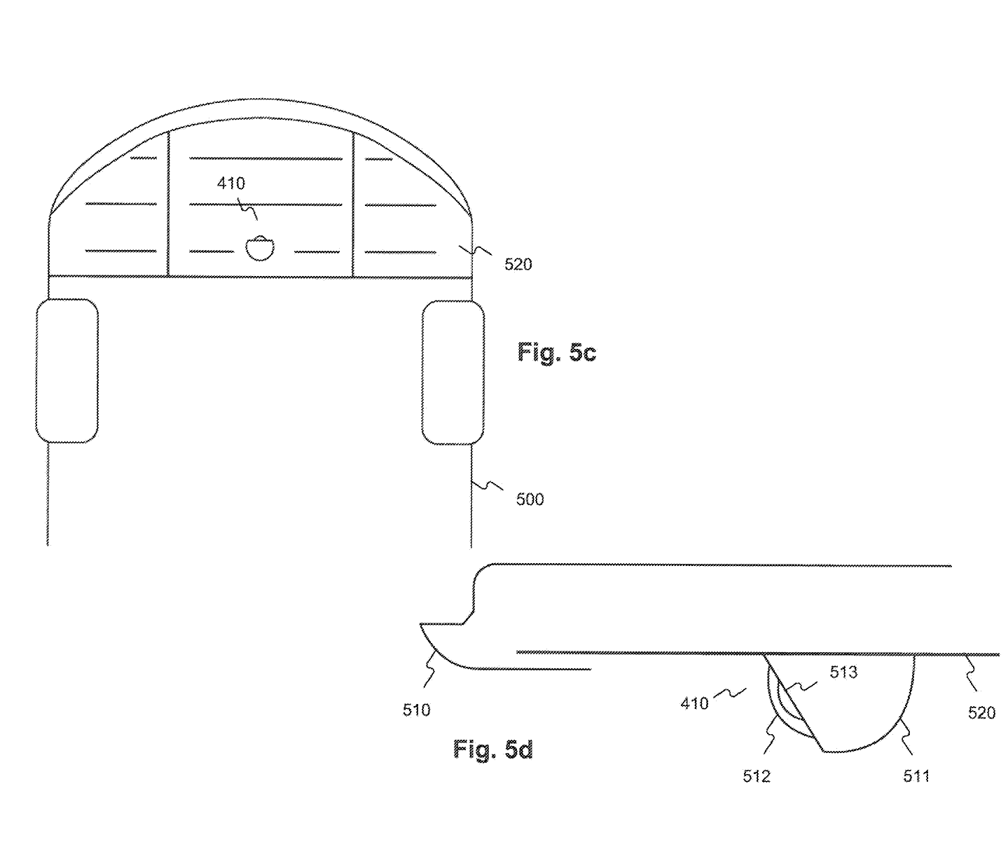

FIGS. 5a-5c depict exemplary placements of components of sensory system 410 on a vehicle 500. In particular, FIG. 5a depicts a side view of vehicle 500 in which sensory system 410 is attached to the underside or undercarriage of vehicle 500. As depicted in the front view of FIG. 5b, sensory system 410 may be positioned such that it represents the object on the body of vehicle 500 that is closest to the ground (other than vehicle 500's tires) or is at a substantially similar height off of the ground as other low-height portions of vehicle 500. In some embodiments, sensory system 410 may be attached to the bottom of a vehicle front bumper 510. In other embodiments, sensory system 410 may be attached to other parts of a vehicle's body, such as certain underside panels that extend forward past the front tires of the vehicle, if such parts lay closer to the ground than a front bumper. FIG. 5c depicts an exemplary placement of sensory system 410 on an underbody panel 520 of vehicle 500.

FIG. 5d depicts a side, front view of bumper 510 and underbody panel 520 of vehicle 500. As depicted in FIG. 5d, sensory system 410 may comprise sensory componentry 513, such as range detector 515 and/or camera device 517. Sensory componentry 513 may be placed within an enclosure 511 and protected by a protective cover 512, such as a glass or plastic semi-sphere. In other embodiments (described below), sensory system 410 may be located at other parts of vehicle 500, such front bumper 510, where it may use estimation techniques to approximate the vantage point it might otherwise have were it located underneath vehicle 500.

In some embodiments, processing system 420 may operate as the “brain” of panel protection system 400 by interpreting sensory information received from sensory system 410 to determine, inter alia, whether such sensory information indicates potential collisions with objects, whether measurements provided by sensory system 410 meet or exceed certain thresholds, and whether and how to alert a vehicle operator, through cabin interface system 430, accordingly. Components of processing system 420 may be located externally to vehicle 500, such as in close proximity to sensory system 410, or internally within vehicle 500, such as within the vehicle dashboard or in a central console area within the vehicle cabin.

Processing system 420 may comprise one or more microprocessors 423 of varying core configurations and clock frequencies; one or more memory devices or computer-readable media 425 of varying physical dimensions and storage capacities, such as flash drives, hard drives, random access memory, etc., for storing data, such as images, files, and program instructions for execution by one or more microprocessors 423; and one or more peripheral components 427 configured to communicate with sensory system 420, cabin interface system 430, or any other peripheral devices or connections.

Cabin interface system 430 may be located internally within vehicle 500, such as within the central console area within the vehicle cabin. Cabin interface system 430 may comprise components configured to provide information or stimuli to a vehicle operator, such as one or more audio speakers 432, one or more illumination components 423, such as multi-colored light-emitting diodes (LEDs), and one or more display screens 436, such as a flat-panel, LCD video screen. Cabin interface system 430 may also comprise components that enable the vehicle operator to control or provide information to panel protection system 400, such as one or more physical controls 437. Physical controls 437 may include traditional physical controls, such as buttons, dials, switches, sliders, and the like. In some embodiments, display screen 436 may function as an input control, such as a graphical user interface (GUI) or touchscreen interface.

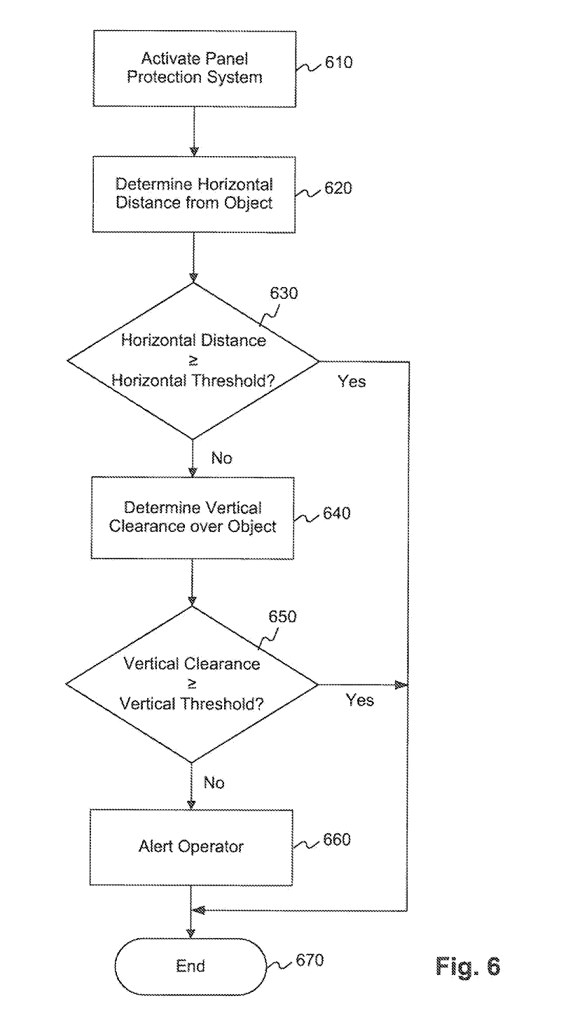

FIG. 6 is a flow diagram depicting an exemplary method of detecting and avoiding collisions with low-height objects, consistent with certain disclosed embodiments. In step 610, panel protection system 400 may be activated. In some embodiments, panel protection system 400 may continually operate at all times, but may notify a vehicle operator only when it detects that the vehicle is being operated in a manner that would necessitate its use. For example, panel protection system 400 may monitor a vehicle's velocity at all times and may activate in user mode only once the velocity falls below a certain threshold, which may indicate that the vehicle is parking rather than driving normally down the road.

In other embodiments, panel protection system 400 may be manually activated by a vehicle operator, for example using a physical control 437, such as a switch or button. Manual activation may be preferred in some cases to preserve power and to avoid disturbing an operator unnecessarily. Since it may be difficult for automated system components to distinguish parking operations from movements in which a vehicle is merely coming to a stop at a red light based solely on vehicle velocity or other factors, manual activation may be used by an operator to use panel protection system 400 only when needed.

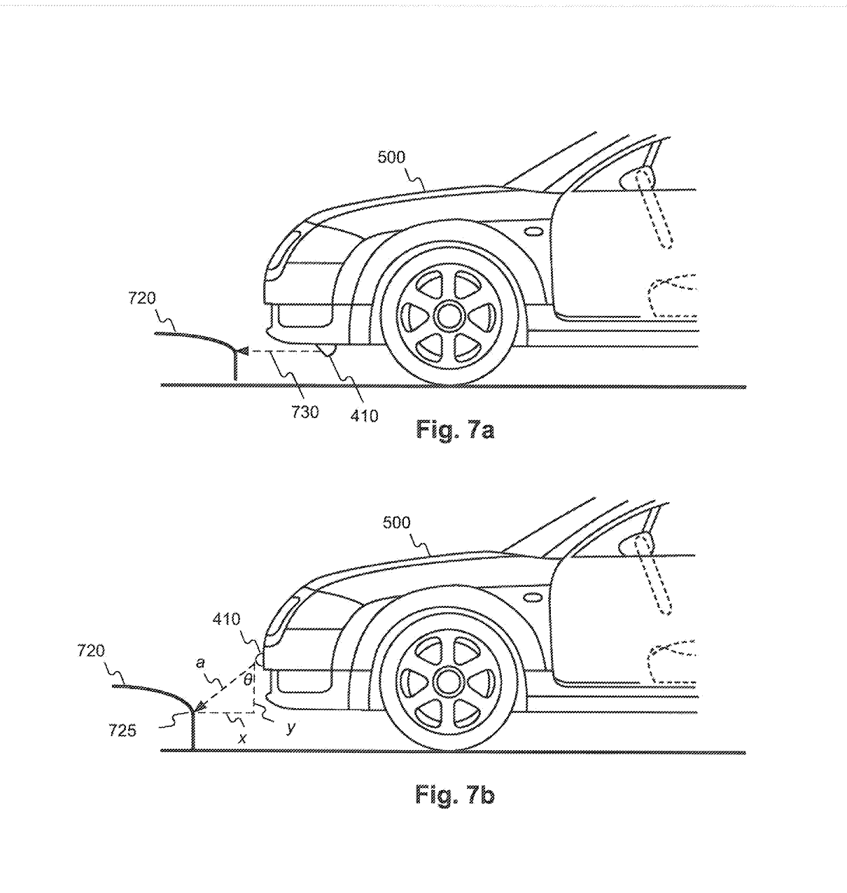

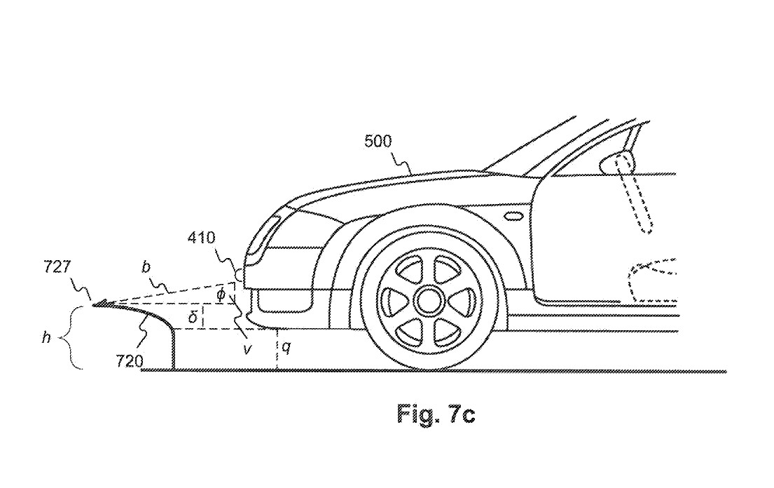

Once panel protection system 400 is activated, in step 620, sensory system 410 may determine its horizontal distance from an object in front of vehicle 500. Sensory system 410 may determine horizontal proximity using ultrasonic range detector 415 or other proximity metric techniques known to those skilled in the art. For example, as depicted in FIG. 7a, if sensory system 410 is placed underneath vehicle 500, such as at a position closest to the ground (or closest to the ground in the section of vehicle 500 protruding forward from its front tires), sensory system 410 may project an ultrasonic sound wave in a direction parallel or substantially parallel to the ground. If sensory system 410 is displaced from the front of vehicle 500 or from a portion of vehicle 500 that may be on course to impact against an object 720, then any measured horizontal distance 730 may be adjusted by subtracting such displacement to arrive at a true horizontal distance between a portion of the vehicle subject to impact and object 720.

In another embodiment, as depicted in FIGS. 7b and 7c, sensory system 410 may be placed toward the front of vehicle 500 and/or above the point on the body of vehicle 500 closest to the ground. In this embodiment, as depicted in FIG. 7b, sensory system 410 may determine a horizontal distance x between the front of vehicle 500 and an object 720 by pointing sensory system 410 downward at an angle θ such that sound waves from sensory system 410 reflect off of object 720 at a point 725 that has a similar vertical displacement from the ground as the lowest point on the body of vehicle 500 (or the lowest point on the underside of vehicle 500 forward of certain portions of any front tires). Then, using sensory system 410′s vertical displacement y from that lowest point, sensory system 410 (or processing system 420) may determine a distance a from point 725, and may calculate horizontal distance x using the equation x=a sin θ. Once again, appropriate adjustments may be made to the calculated horizontal distance as necessary.

In step 630, sensory system 410 and/or processing system 420 may determine whether the measured horizontal distance meets or exceeds a horizontal threshold. The horizontal threshold may be a predetermined distance between a part of vehicle 500 (e.g., a part of the vehicle that could collide with the object if a current trajectory is maintained) and the detected object such that cabin interface system 430 will not alert a vehicle operator provided the horizontal distance is greater than the horizontal threshold. Using this technique, panel protection system 400 may ignore objects that are too remote from vehicle 500 on the assumption that there is a low likelihood of collision with such objects unless or until vehicle 500 gets closer.

Thus, if the horizontal distance is greater than or equal to the horizontal threshold (step 630, Yes), then panel protection system 400 may ignore the object, and processing may temporarily halt (step 670)—for example, until the horizontal distance changes. If the horizontal distance is less the horizontal threshold (step 630, No), then processing may continue. In some embodiments the horizontal threshold may be dynamically determined in proportion to the velocity or speed of the vehicle, such that a greater velocity or speed will result in a greater horizontal threshold and a lower velocity or speed will result in a lesser horizontal threshold.

In embodiments where sensory system 410 is located at a point on the body of vehicle 500 closest to the ground, as depicted in FIG. 7a, determining horizontal distance may be sufficient to detect a potential collision. For example, if sensory system 410 projects ultrasonic sound waves in a direction parallel or substantially parallel to the ground, it may be sufficient to simply detect horizontal proximity to object 720, without the need to detect vertical proximity. It may be assumed that such sound waves would not reflect back from any object lower than sensory system 410 and, thus, any such object would not collide with any part of the body of vehicle 500, since sensory system 410 represents the lowest part of the body.

In other embodiments where sensory system 410 is not located at a point on the body of vehicle 500 closest to the ground, it may be necessary to determine a vertical clearance over any detected object (step 640). Sensory system 410 may determine such a vertical clearance in the following manner. Sensory system 410 may adjust the angle at which it directs its sound waves until it arrives at an angle φ such that its sound waves reflect off of the highest point 727 of object 720 (e.g., the greatest angle φ such that, at any greater angle, sound waves would not bounce off of object 720, on account of “overshooting” object 720).

Next, sensory system 410 may measure the distance b between sensory system 410 and point 727, and may use such distance to compute its vertical displacement v from point 727 using the equation v=b cos φ. Sensory system 410 may derive the vertical displacement of point 727 from the ground, and thus the height of object 720 using the equation h=c−v, where c (not depicted) represents sensory system 410's vertical displacement from the ground. Finally, sensory system 410 may determine the vertical clearance δ of the body of vehicle 500 over object 720 using the equation δ=h−q, where q represents the vertical displacement of the lowest point of the body of vehicle 500 from the ground (or the lowest point forward from the front tires). Although described in the context of scenarios in which sensory system 410 is not the lowest point on the body of vehicle 500, the vertical measurements of step 640 may also be taken in the scenario when sensory system 410 is at the lowest point—e.g., to improve accuracy or precision.

In step 650, panel protection system 400 may determine whether the determined vertical clearance meets or exceeds a vertical threshold. In some embodiments, the vertical threshold might be zero, indicating that any vertical clearance lower than the threshold would result in a horizontal collision between some part of the body of vehicle 500 and the object. In other embodiments, the vertical threshold might be a positive number in order to provide an adequate buffer between the lowest vertical components of the body of vehicle 500 and the object to account for potential variations such as tire pressure, bounce in the vehicle's shocks, minor systematic or random error in the measurements of sensory system 410, etc.

If the vertical clearance is found to meet or exceed the vertical threshold (step 650, Yes), then it may be assumed that the vehicle has sufficient vertical clearance over the object that a collision is not likely. In that case, it may not be necessary to alert the driver or take other action, and processing may temporarily halt (step 670)—for example, until or unless the vertical clearance changes. If the vertical clearance is less than the vertical threshold, however (step 650, No), then it may be assumed that some part of vehicle 500 will collide with the object if the vehicle continues to approach the object. Accordingly, in step 660, cabin interface system 430 may alert the operator of the vehicle.

Alerting the operator may take many different forms. In some embodiments, cabin interface system 430 may activate one or more lights 434 to alert the operator of an impending collision. For example, cabin interface system 430 may display one or more lights using a first color when the vehicle is within a first horizontal range of the detected object, using a second color when the vehicle is within a second, smaller horizontal range of the detected object, and so forth, to increase the level of warning to the operator as the vehicle gets closer to the object. Similarly, cabin interface system 430 may project one or more sounds using one or more speakers 432. For example, cabin interface system 430 may provide pre-recorded or computer-generated voice notifications, such as indicating the vertical clearance and/or the horizontal distance of the vehicle in an incremental fashion as the vehicle approaches the object. Cabin interface system 430 may also alert the vehicle operator using any number of graphical displays that could be provided through display screen 436.

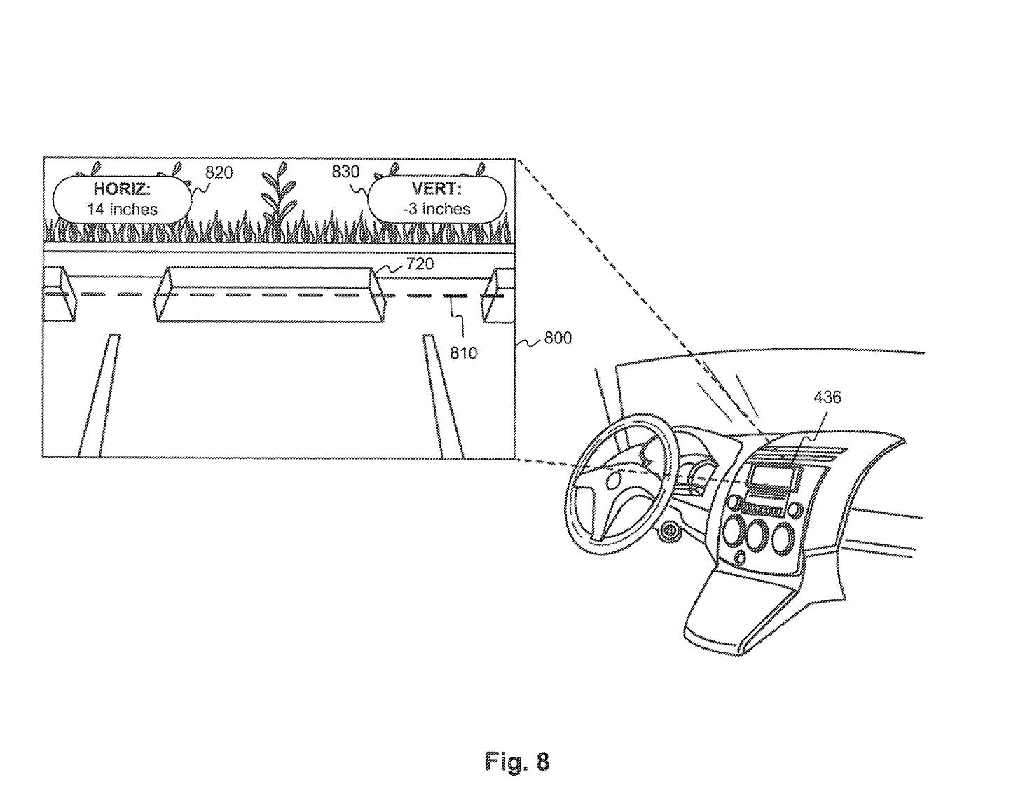

In other embodiments, alerting the operator may the take the form of displaying one or more real-time images on display screen 436. For example, as depicted in FIG. 8, display screen 436 may be activated to provide a real-time video display 800 of images captured by camera device 417. Video display 800 may enable the operator to view any objects 720 that may present potential collision from the vantage point of sensory system 410 (e.g., from the underside of vehicle 500), objects which might otherwise not be visible from the direct vantage point of the operator or the vantage point of a video device embedded into the bumper or located at a higher point than the part of the vehicle subject to potential collision. Panel protection system 400 may use various lens or digital image enhancement techniques to manipulate the video display 800 to magnify any nearby objects or to provide greater visual context.

Video display 800 may also include graphical elements that are superimposed over the video feed in order to provide the operator with additional metrics or information with respect to the vehicle's or specific portions of the vehicle's relation to the objects 720. For example, video display 800 may include a superimposed line 810 that represents the vertical clearance of vehicle 500 over any nearby objects. As depicted in FIG. 8, it can be seen that vehicle 500 would not clear object 720, since vertical clearance line 810 is lower than the height of object 720.

Video display 800 may also include superimposed graphical areas 820 and 830 that inform the operator of the precise horizontal distance and vertical clearance, respectively, of the vehicle with respect to a nearby object. One or more additional lighting devices (not depicted) may also be placed on the underside of vehicle 500 or near sensory system 410 to provide adequate lighting for any images or video captured by camera device 417. Those skilled in the art will appreciate that the precise configuration and features of video display 800 depicted in FIG. 8 are exemplary only, and other metrics, measurements, or messages could be provided in graphical areas 820 and 830.

For example, the video display 800 depicted in FIG. 8 presents a view of nearby objects from an angle that is directed downward relative to the horizontal. Such a view may correspond to the placement of sensory system 410 toward the front of vehicle 500 and at a vertical position higher than the vertical clearance of vehicle 500, such as depicted in FIGS. 7b and 7c. In other embodiments, such as that depicted in FIG. 7a, sensory system 410 may be located at or near the clearance point of vehicle 500. In these embodiments, video display 800 may present a view of nearby objects in a manner similar to that depicted in FIG. 8, but using a view that is substantially parallel to the ground. Such a view may additionally include portions of the front lower underside of vehicle 500—e.g., the portions for which vertical clearance is sought to be determined—so that a vehicle operator can visually discern that certain front lower underside portions may not vertically clear nearby objects that are also displayed. In these embodiments, for example, it may not be necessary to depict a virtual clearance line 810, since a vehicle operator may be able to discern the actual clearance line by using the displayed lower front portions as a reference.

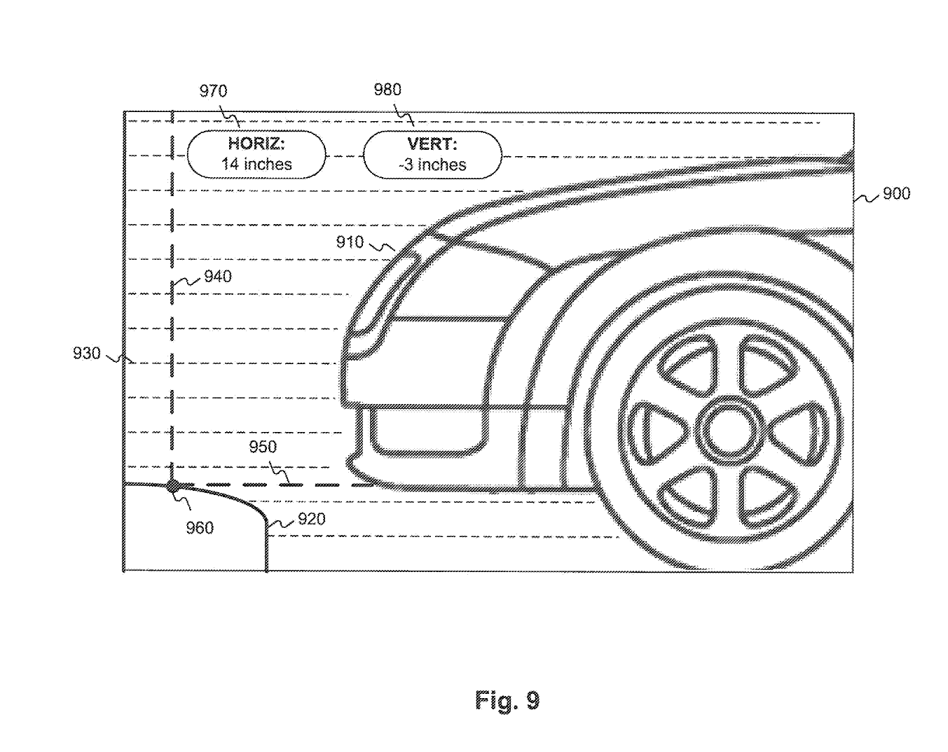

In another embodiment, rather than, or in addition to, displaying a real-time video display 800 in display screen 436, cabin interface system 430 may display a computer-generated virtual grid 900 representing a virtual depiction of the spatial relationships between parts of vehicle 500 and one or more nearby objects. For example, as depicted in FIG. 9, virtual grid 900 may comprise a computer-generated representation 910 of vehicle 500, which may be constructed using known dimensions of vehicle 500, and a computer-generated representation 920 of external object 720, which may be constructed using sonar, image or light analysis, or other techniques to determine shape and size.

Virtual grid 900 may additionally include a series of horizontal gridlines 930 or vertical gridlines (not depicted) to aid the operator in discerning vertical and horizontal spatial relationships between vehicle 500 and the object 720. Virtual grid 900 may also include an emphasized vertical line 940 and an emphasized horizontal line 950 that intersect at the point 960 at which panel detection system 400 has determined that vehicle 500 will collide with object 720 if a current trajectory or velocity is maintained. And, like video display 800, virtual grid 900 may include graphical areas 970 and 980 that inform the operator of the precise horizontal distance and vertical clearance, respectively, of the vehicle with respect to object 720.

In some embodiments, video display 800 and/or virtual grid 900 may be displayed as form of alert after panel protection system 400 has determined that the horizontal distance and/or vertical clearance fall within certain ranges, as depicted in FIG. 6. In other embodiments, a vehicle operator may simply rely on his or her own judgment by activating a control on cabin interface system 430 to provide video display 800 and/or virtual grid 900 on display screen 436 when the operator believes it necessary or helpful, such as when commencing a parking or other driving operation for which the operator desires to have additional perspective to detect or avoid a potential collision.

In addition to, or in lieu of, alerting the vehicle operator once a potential collision has been detected, panel protection system 400 may exercise control over vehicle 500 by applying brakes, reducing acceleration or speed, adjusting wheel suspension or hydraulics, lifting a bumper or lower panel, or engaging in other operations to prevent a potential collision.

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. For example, the invention is equally applicable both to forward motion by the vehicle and backward motion.

Those skilled in the art will also appreciate that the steps described need not be performed in the same sequence discussed or with the same degree of separation. Likewise, various steps may be omitted, repeated, or combined, as necessary, to achieve the same or similar objectives or enhancements. Accordingly, the invention is not limited to the above-described embodiments, but instead is defined by the appended claims in light of their full scope of equivalents.

1. An automotive collision detection system, comprising:
a sensor attached to an automotive vehicle, wherein the sensor is configured to:
determine a location of a highest-elevation point of an object external to the vehicle;
measure a vertical clearance of a portion of an underside of the vehicle with respect to the highest-elevation point of the object external to the vehicle;
determine a location of a horizontally-closest point on the object that is horizontally closest to the portion of the underside of the vehicle; and
measure a horizontal distance from the portion of the underside of the vehicle to the horizontally-closest point of the object,
wherein the sensor is located at a higher elevation than the underside of the vehicle;
a processor coupled with the sensor and configured to calculate a difference between the vertical clearance and a vertical clearance threshold and to compare the horizontal distance with a horizontal threshold; and
a user-interface component located within a cabin area of the vehicle and coupled to the sensor, the processor, or both, wherein the user-interface component is configured to alert an operator of the vehicle when the sensor, the processor, or both determines that the vertical clearance is less than the vertical clearance threshold and that the horizontal clearance is less than the horizontal threshold.

2. (canceled)

3. The system of claim 1, wherein:
the user-interface component comprises one or more speakers; and
the user-interface component is configured to alert the operator of the vehicle at least by transmitting one or more sounds from the one or more speakers.

4. (canceled)

5. The system of claim 1, wherein:
the user-interface component comprises one or more illumination components configured to emit light; and
the user-interface component is further configured to alert the operator of the vehicle at least by emitting light from the one or more illumination components.

6. (canceled)

7. The system of claim 1, wherein:
the user-interface component comprises one or more display screens; and
the user-interface component is further configured to alert the operator of the vehicle at least by displaying graphical information, or textual information, or both, on the one or more display screens related to the vertical clearance.

8. (canceled)

9. The system of claim 7, further comprising:
a video camera attached to the vehicle, wherein the video camera is configured to capture images representing a spatial relationship between the portion of the underside of the vehicle and the object; and
the user-interface component is further configured to alert the operator of the vehicle at least by displaying the images on the one or more display screens in real-time as the vehicle approaches the object.

10. The system of claim 7, wherein the user-interface component is further configured to display a virtual grid depicting the spatial relationship between the portion of the underside of the vehicle and the object on the one or more display screens.

11. An automotive collision detection system, comprising:
a video camera attached to an underside of an automotive vehicle, wherein the video camera is configured to capture images representing one or more spatial relationships between a portion of the underside of the vehicle and an object external to the vehicle;
a sensor configured to measure a vertical clearance of the portion of the underside of the vehicle with respect to the object;
a processor configured to calculate a difference between the vertical clearance and a vertical clearance threshold; and
one or more display screens located within a cabin area of the vehicle and coupled to at least the video camera, wherein the one or more display screens are configured to display the images in real-time as the vehicle approaches the object and display the difference, the vertical clearance, the vertical clearance threshold, or a combination thereof, wherein the one or more display screens are further configured to display a virtual grid superimposed on the images, the vertical grid comprising lines demarking vertical clearance increments with respect to the underside of the vehicle.

12. (canceled)

13. A method of protecting against collision between a portion of an underside of an automotive vehicle and an object external to the vehicle, the method comprising:
determining, using a sensor attached to the vehicle, a location of a vertical top-most portion of the object where the object extends to its greatest height from the ground and a location of a horizontally-closest portion of the object that is horizontally closest to the portion of the underside of the vehicle;
measuring, using the sensor attached to the vehicle, a vertical clearance of the portion of the underside of the vehicle with respect to the vertical top-most portion of the object external to the vehicle;
measuring, using the sensor, a horizontal distance between the horizontally-closest portion of the object and the portion of the underside of the vehicle;
determining that the horizontal distance is less than a horizontal threshold;
calculating a difference between the vertical clearance and a vertical clearance threshold;
determining that the vertical clearance is less than or equal to a the vertical clearance threshold; and
alerting an operator of the vehicle using a user-interface component located within a cabin area of the vehicle in response to determining that the horizontal distance is less than the horizontal threshold and that the vertical clearance is less than or equal to the vertical clearance threshold.

14. The method of claim 13, wherein the sensor is mounted on or near the portion of the underside of the vehicle for which the vertical clearance is measured.

15. The method of claim 13, wherein:
the user-interface component comprises one or more speakers; and
alerting the operator of the vehicle comprises transmitting one or more sounds from the one or more speakers.

16. The method of claim 15, further comprising:
measuring a horizontal distance between the portion of the underside of the vehicle and the object,
wherein alerting the operator of the vehicle comprises transmitting one or more sounds from the one or more speakers indicating the horizontal distance as the vehicle approaches the object.

17. The method of claim 13, wherein:
the user-interface component comprises one or more illumination components configured to emit light; and
alerting the operator of the vehicle comprises emitting light from the one or more illumination components.

18. The method of claim 17,
wherein alerting the operator of the vehicle comprises emitting light using different arrangements of the one or more illumination components, or emitting differing colors from the one or more illumination components, or both, as the vehicle approaches the object.

19. The method of claim 13, wherein:
the user-interface component comprises one or more displays screens; and
alerting the operator of the vehicle comprises displaying graphical information, or textual information, or both, on the one or more display screens related to the vertical clearance.

20. The method of claim 19,
wherein alerting the operator of the vehicle comprises displaying the horizontal distance on the one or more displays screens as the vehicle approaches the object

21. The method of claim 19, comprising:
capturing images representing a spatial relationship between the portion of the underside of the vehicle and the object using a video camera attached to the vehicle,
wherein alerting the operator of the vehicle comprises displaying the images on the one or more display screens in real-time as the vehicle approaches the object.

22. The method of claim 19, wherein alerting the operator of the vehicle comprises:
displaying a virtual grid depicting a spatial relationship between the portion of the underside of the vehicle and the object on the one or more display screens, wherein the virtual grid comprises lines that demark vertical distance increments with respect to the underside of the vehicle.

23. An automatic collision detection system, comprising:
a sensor coupled to a vehicle, the sensor being configured to measure a vertical clearance between the sensor and an vertically highest point of an object external to the vehicle and to measure a horizontal distance between the sensor and a point on the object that is horizontally closest to the sensor;
a processor coupled with the sensor and configured to receive data indicative of the vertical clearance and the horizontal distance from the sensor and to calculate a difference between the vertical clearance and a vertical clearance threshold and to compare the horizontal distance and the horizontal clearance; and
a user-interface component coupled with the processor, the user-interface component being configured to alert an operator of the vehicle when both the vertical clearance is less than the vertical clearance threshold and the horizontal distance is less than the horizontal threshold.

24. The system of claim 23, wherein the sensor is positioned vertically above the portion of the underside of the vehicle.

25. The system of claim 1, wherein the sensor is configured to determine the location of the horizontally-closest point of the object independently from the location of the highest-elevation point of the object.

26. The system of claim 1, wherein the processor is further configured not to alert the operator unless the horizontal distance is less than a horizontal threshold.

27. The system of claim 10, wherein the virtual grid comprises lines that demark increments of vertical distance with respect to the underside of the vehicle.
